(19) United States
(12) Patent Application Publication
(10) Pub. No.: US 2015/0182310 A1
(43) Pub. Date: Jul. 2, 2015

(54) DENTAL IMPLANT

(71) Applicants: Ardavan Fateh, Denver, CO (US); Emilio Ivan Arguello, Aurora, CO (US)

(72) Inventors: Ardavan Fateh, Denver, CO (US); Emilio Ivan Arguello, Aurora, CO (US)

(21) Appl. No.: 14/588,726

(22) Filed: Jan. 2, 2015

Related U.S. Application Data
(60) Provisional application No. 61/922,844, filed on Jan. 1, 2014.

(51) Int. Cl. A61C 8/00; A61C 13/08

(52) U.S. Cl. CPC A61C 8/0022; A61C 8/0074; A61C 13/08

(57) ABSTRACT

A dental implant system comprising a crown, an abutment, and an implant. In one embodiment, the abutment is one of coupled and integrated to the crown. The implant may comprise an upper portion adapted to receive the abutment. The upper portion may comprise an inner implant surface having a first angle relative to a vertical plane. In one embodiment, the first angle is less than about twenty degrees or more than about sixty degrees.

### PRIORITY

This application claims priority to U.S. Provisional Application No. 61/922,844, filed Jan. 1, 2014 and entitled “Dental Abutment and Implant,” which is incorporated herein by reference in its entirety.

### FIELD OF THE INVENTION

This invention relates to dental devices. In particular, but not by way of limitation, the present invention relates to a dental implant.

### BACKGROUND OF THE INVENTION

Current dental implant designs are inadequate in various aspects. For example, substantial bone loss occurs proximal to many dental implants. This bone loss around a dental implant is one of the biggest contributing factors in the failure of dental implants. Although different surgical techniques and implant designs have been developed over the years to prevent bone loss, these techniques and designs have not been completely successful. Additionally, many implants provide sub-optimal esthetic results as substantial soft tissue discrepancies often occur between the implants and natural teeth and between two adjacent implants. Bone loss after dental implant placement is often dependent on biologic width (BW) establishment and/or presence of a microgap at an implant junction.

### SUMMARY OF THE INVENTION

In order to overcome the deficiencies of the prior art, one aspect of the current invention aims to help clinicians preserve the bone around the neck of the dental implants by (i) ensuring that there is enough room to establish a BW within a specified BW range and (ii) re-designing of the microgap location.

One embodiment of the invention comprises a dental implant system comprising a crown, an abutment one of coupled and integrated to the crown, and a dental implant. The dental implant comprises an upper portion adapted to receive the abutment, with the upper portion comprising an inner implant surface. The inner implant surface comprises a first angle relative to a vertical plane that is less than about twenty degrees or more than about sixty degrees.

Another embodiment of the invention comprises a dental implant. One dental implant comprises a first section and a second section. The first section is adapted to couple to soft tissue. The second section is adapted to couple to bone. The first section is further adapted to create a biologic width in the soft tissue. One biologic width comprises a horizontal distance and a vertical distance, and is adapted to minimize bone loss.

Yet another embodiment of the invention comprises a method of installing a dental implant. One method comprises coupling the dental implant to soft tissue and bone, coupling a dental abutment to the dental implant, creating one or more spaces between the dental abutment and the dental implant, and facilitating growth of the soft tissue in the one or more spaces.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1A depicts a side view of a dental implant system according to one embodiment of the invention;

FIG. 1B depicts a side view of a biologic width according to one embodiment of the invention;

FIG. 2A depicts a side cross-sectional view of a dental implant according to one embodiment of the invention;

FIG. 2B depicts a top view of a dental implant according to one embodiment of the invention;

FIG. 2C depicts a cross-sectional view of a portion of a dental implant according to one embodiment of the invention; and

FIG. 3 depicts a method of installing a dental implant according to one embodiment of the invention.

### DETAILED DESCRIPTION

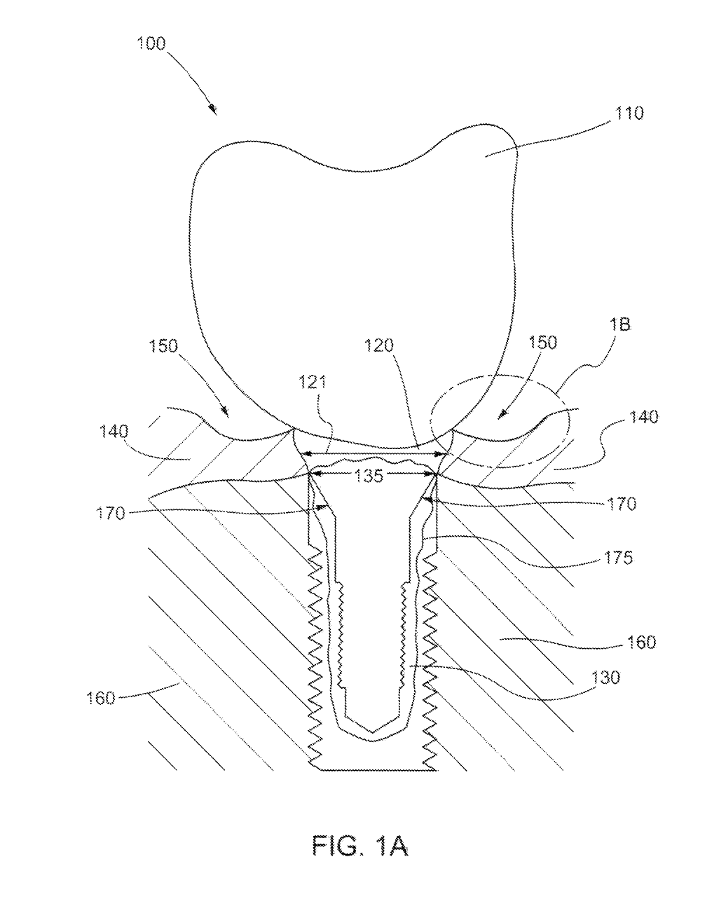

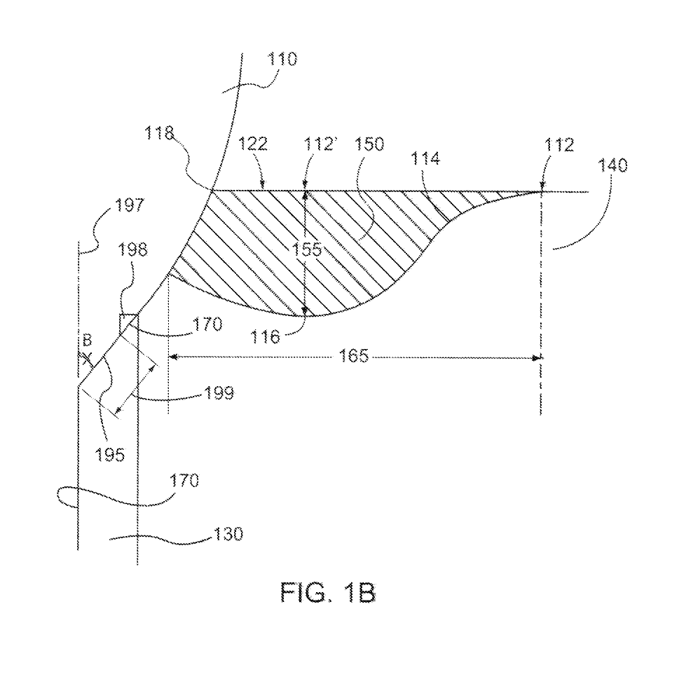

Turning first to FIG. 1A, seen is a dental implant system 100 comprising a crown 110, abutment 120 and implant 130 located in soft tissue 140 and bone 160. A biologic width 150 (also referred to herein as the BW 150) may comprise an area between the soft tissue 140 (e.g. a patient's gum line) and a top part of the bone 160). Biologic width provides sufficient dimension for periodontal attachment apparatus to establish, and consequently prevents bone loss. As seen in the close-up of Section 1B in FIG. 1B, one BW 150 may comprise both a vertical distance 155 and a horizontal distance 165. One vertical distance 155 may extend from a lowest point 116 on a gum line 114 proximal the crown 110 or other tooth or tooth structure to a location 112′ located gum line substantially vertically above the lowest point. One location 112′ comprises a same vertical location as a gum line location 112. One gum line location 112 comprises a vertical and horizontal point where the gum line 114 is initially substantially or generally horizontal. Similarly, one horizontal distance 165 may comprise a distance that extends generally or substantially horizontally from a crown location 118 (or a location on a tooth or other tooth structure) to the gum line location 112. As seen by the shaded area in FIG. 1B, the BW 150 may comprise an area extending between the crown 110, gum line 114, and a horizontal line 122 extending from the crown 110 to the gum line location 112.

As seen in FIG. 1A, in order to maintain healthy soft tissue 140 and bone 160 around the dental implant system 100, as well as minimizing or preventing any loss of the bone 160 near the dental implant system 100, the vertical distance 155 and horizontal distance 165, seen in FIG. 1B, of the biologic width 150 should be maintained within a specified range. One such range may comprise a vertical distance 155 and/or a horizontal distance 165 of about 2.5 to 3.5 mm. However, greater or smaller distances are also contemplated. For example depending a tooth size and/or location in the mouth, the vertical distance 155 and/or a horizontal distance 165 may be larger or smaller, potentially from 0.5 mm to 5.5 mm. However, if the size of the BW 150 is outside of a predetermined range, either due to a too-large vertical distance 155 and/or a too-large horizontal distance 165, bone 160 resorption may occur, which may lead to significant bone 160 loss and the failure of one or more features of the dental implant system 100. Another cause of bone 160 resorption may be due the presence and/or accumulation of bacteria and any bacteria by-products at a junction between the implant 130, also referred to herein as an implant fixture, and the abutment 120, also referred to herein as a restorative abutment. This junction is referred to as the inclined platform 170, as seen through the cutaway portion 175 of the implant 130 in FIG. 1A. Through this inclined platform 170, the system 100 seen in FIG. 1A is adapted to decrease soft tissue 140 discrepancies between implants 130 and natural teeth or two adjacent implants 130. The inclined platform 170 may comprise a portion of an inner implant surface

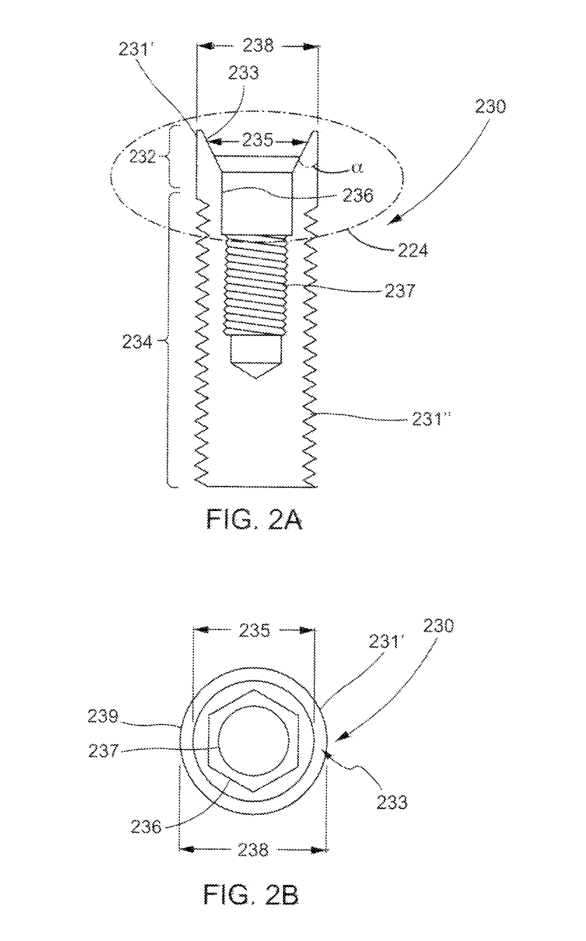

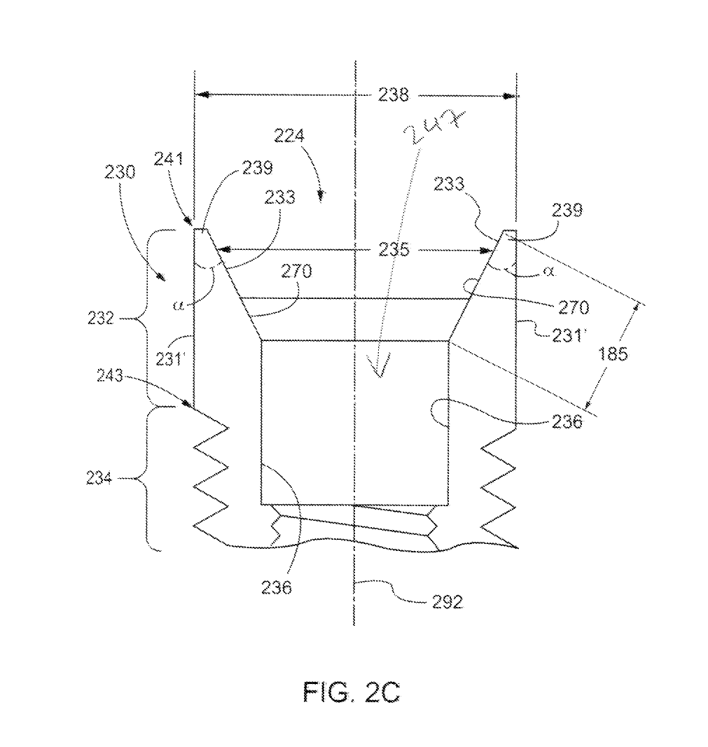

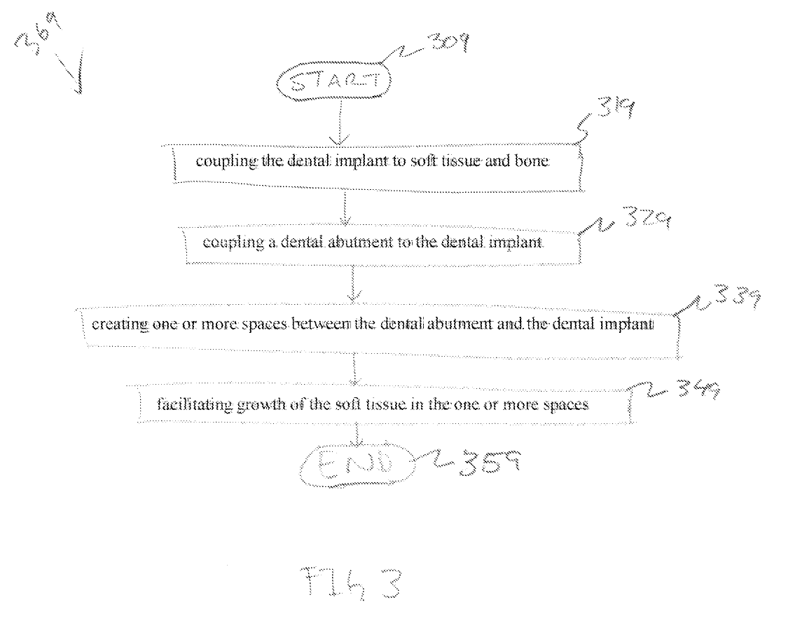

Turning now to FIG. 2A, seen is a cross-sectional side-view of the implant 130 seen in FIG. 1A. FIG. 2B is the top view of the implant 230 seen in FIG. 2A. FIG. 2C is a view of section 224, showing a close-up of the inclined platform 270. As seen in these figures, the implant 230 may comprise a generally cylindrical shape and may comprise a first vertical section 232 and a second vertical section 234 with an outer surface 231′ of the first vertical section 232 in at least one embodiment comprising a micro threaded circular outer surface adapted to interact with the bone 160, as seen in FIG. 1A. The first vertical section 232 may be referred to herein as a first section and the second vertical section 234 may be referred to here as a second section. Also, an outer surface 231″ of the second vertical section 234 may comprise a substantially threaded circular outer surface 231″ adapted to interact with the bone 160 as seen in FIG. 1A. The micro threads may be referred to herein as a first coupling mechanism and the threaded circular outer surface may be referred to herein as a second coupling mechanism. Other coupling mechanisms known in the art besides micro threads and threads are contemplated.

As seen in FIG. 2C, the first vertical section 232 may comprise a proximal end 241 and a distal end 243 and the implant 230 may comprise a bore 247. The bore 247 may extend at least partially through the first section and second section and be adapted to receive the abutment 120. The bore 247 may comprise the inclined platform 270, which may also be referred to herein as an inclined surface. As seen, the inclined surface may extend from near the outer surface 231′ at or near the proximal end 241 towards the centerline 292 near the distal end 243. Furthermore, as seen in FIGS. 2A-2C, a first vertical section 232 may comprise be comprised of an upper portion inner surface 233 and may also comprise at least part of a lower portion inner surface 236. The upper portion inner surface 233 may also be referred to herein as an upper portion 233 while the lower portion inner surface 236 may also be referred to herein as the lower portion 236. The lower portion 236 may extend into the second vertical section 234 and may receive and couple to a portion of the abutment 120 seen in FIG. 1A.

In the embodiments shown in FIGS. 1A-2B, the implant 130, 230 and abutment 120 may couple together through an abutment portion comprising an implant coupling mechanism. One implant coupling mechanism may couple to an implant threaded coupling mechanism, as seen in FIG. 2A. One threaded coupling mechanism comprises a second vertical section 234 of the implant 230, with the second vertical section 234 having an inner threaded female section 237. This inner threaded female section 237 is adapted to receive an outer threaded male section of the abutment 120 from FIG. 1A, although other non-threaded abutment-implant coupling mechanisms known in the art are also contemplated. Returning again to FIGS. 2A-2C, as seen, the upper portion 233 may comprise the inclined platform 270, 170, also seen in FIG. 1. One inclined platform 170, 270 may mate with a surface on the abutment 120, as seen in FIG. 1A with the abutment 120 coupled to the implant 130. Such a surface on the abutment may comprise an abutment surface 195, as seen in FIG. 1B. The abutment surface may comprise the same length as the length 185 of the inner implant surface. It is also contemplated that an abutment surface length 199 may be less than the inner implant surface length 185. In such an embodiment, the abutment surface 195 may only contact a portion of the inclined platform 170. Alternatively, the abutment surface length 199 may be greater than the inner implant surface length 185. Furthermore, the gum line 114 may be located at or near the abutment surface 195. In either embodiment, one or more spaces 198 may be created between the abutment 120 and the implant 130. For example, the space 198 seen in FIG. 1B comprises a space 198 near the inclined platform 170 when the abutment surface 195 is shorter than the inclined platform 170. The soft tissue 140 may brow into the open space 198. In one embodiment, soft tissue may be manually placed in the open space 198 in order to facilitate growth. It is also contemplated that the implant 130, 230 and abutment 120 may be integrated, thereby comprising a single unitary device.

As seen in FIGS. 2A-2C, the upper portion 233 may comprise a substantially-flat inwardly-sloping section comprising the inclined platform 270. However, it is also contemplated that the upper portion 233 may comprise another shape such as, but not limited to, an upper portion 233 having one or more surface features adapted to make the upper portion generally non-flat—such as, but not limited to, one or more raise sections or one or more notches in the upper portion 233. One or more sections of the upper portion 233 may also slop outwardly or comprise a substantially vertical or horizontal shape, or may comprise a portion which slopes outwardly and a portion which slopes inwardly.

An opening of the upper portion 233 may comprise a first diameter 235 while the outer surface 231′ of the upper portion 233 may comprise a second diameter 238. In one embodiment the section 239 between the first diameter 235 and the second diameter 238 may comprise a section 239 having a generally rounded surface. However, this section 239 may comprise a generally flat surface, as seen in FIG. 2C, or may comprise any other shape as well.

As seen in FIG. 1A, the first diameter 135 may be smaller than an abutment diameter 121. However, it is contemplated that the abutment diameter 121 may comprise the same or a smaller size than the first diameter 135. The difference between the abutment diameter 121 and the first diameter 135 and/or the second diameter 238, as seen in FIGS. 2A-2C, may comprise a platform switch or a platform shift. Different implant 230 surface treatments and platform switch/shifts may be incorporated to maintain the bone 160 around the implant 130, as seen in FIG. 1A. Platform switching is a method utilized to preserve alveolar bone levels around the implant 130. Basically, this concept may apply when narrower diameter 121 restorative abutments are placed on implants 130 of wider diameter 135, as opposed to placing abutments 120 of similar diameters. A smaller abutment diameter 121 as compared to the first diameter 135 may help with bone 160 preservation by (a) providing an additional horizontal distance 165 to BW and/or (b) placing the inclined platform 170 as close as possible to a centerline 292 of the implant 230, as seen in FIG. 2C.

The use of the inclined platform 170, 270 on the implant 130, 230 seen in FIGS. 1A and 2A enables the soft tissue 140 to grow around and seal any spaces between the abutment 120 and the implant 130, or any other spaces created in and around the abutment 120 and/or the implant 130. Such growth near the BW 150 helps ensure that the BW 150 is within the desired range and substantially diminishes or even generally eliminates bacteria and bone loss at and near the system 100, including at or near the inclined platform 170, 270. Such inclined platform 170 on the implant 130 may be adapted for use with an abutment 120 having a similarly-aligned mating incline adapted to align with the inclined platform 170, though an abutment 120 mating incline may comprise a diameter that is greater than, the same as, or less than, the diameter 235 of the inclined platform 170.

Alternatively, the abutment 120 may not comprise an abutment 120 adapted to align with the inclined platform 170 and the abutment 120 may comprise a substantially horizontal platform, or any other shape known in the art. Through the use of, for example, a horizontal abutment platform, space between the abutment 120 and implant 130 may be crated for the soft tissue 140 to grow. Such growth of soft tissue 140 may lead to an increased horizontal distance 165 for the BW 150, which may require less of a need to establish the vertical distance 155, and may therefore lead to lower bone loss. It is also contemplated that the gap (which may also be referred to herein or elsewhere as a microgap) between the implant 130 and the abutment 120 along the inclined platform 170 may be sealed by soft tissue 140 growth upon placing the soft tissue 140 inside the implant 130 prior to, or after installation of the implant 130 into the soft tissue 140 and bone 160. Furthermore, any bacterial growth that does in or near the system 100 may be sealed by the soft tissue growth and unable to escape the inclined platform 170 area. Such a design will minimize the bone loss around dental implants 130 and therefore increase the longevity of the dental implant.

As seen in FIG. 2A, the implant 230 may also comprise an angle α. One angle α comprises the angle between the inclined platform 270 and the outer surface 231′ of the first vertical section 232, as seen in FIG. 2C. The first vertical section 232 may also be referred to herein as a vertical plane. One embodiment of the implant 230 may comprise an angle α that is less than about 20° or greater than about 60°. It is also contemplated that at least a part of the upper portion 233 may not contact the abutment 120 to leave room for soft tissue 140 growth and BW 150 formation and may comprise a different angle α than a lower part of the upper portion 233, where the abutment 120 may be in direct contact with the implant 130, creating a microgap between the two. In one embodiment, the top 50% of the upper portion 233 may not contact the abutment, while in another embodiment it may be about the upper 75%, 25%, 1% or anything in-between these figures. As seen in FIG. 1B, an angle β may also be created by the abutment surface 195 and a vertical plane 197. The angle β may be substantially equal to the angle α.

Turning now to FIG. 3, seen is a method 369 of installing a dental implant 230. One method 369 starts at 309 and at 319 comprises coupling the dental implant 230 to soft tissue 140 and bone 160. At 329 the method 369 comprises coupling a dental abutment 120 to the dental implant 130, while at 339 the method 369 comprises creating one or more spaces 295 between the dental abutment 120 and the dental implant 130. Finally, at 349 the method 369 comprises facilitating growth of the soft tissue 140 in the one or more spaces 198, with the method 369 ending at 359.

Although not seen in FIG. 3, in one method 369, the soft tissue 140 may comprise a gum within a person's mouth and the gum may have a gum line 114. Such a method 369 may further comprise establishing a biologic width 150 in the gum proximal at least one of the dental implant 130 and dental abutment 120. Furthermore, the biologic width 150 may comprise a horizontal distance 165 and a vertical distance 155 and at least one of the horizontal distance 165 and the vertical distance 155 may be changed upon growth of the soft tissue 140 in the one or more spaces 198. It is also contemplated that the step 329 of coupling a dental abutment to the dental implant may comprise placing the dental abutment 120 against an inclined surface of the dental implant 130, with placing the dental abutment against an inclined surface of the dental implant comprising placing a dental abutment inclined surface against the inclined surface of the dental implant. The dental abutment inclined surface may comprise a diameter 121 different than a diameter 135 of the inclined surface of the dental implant.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A dental implant system comprising,
a crown;
an abutment one of coupled and integrated to the crown; and
an implant comprising an upper portion adapted to receive the abutment, wherein the upper portion comprises an inner implant surface having a first angle relative to a vertical plane that is less than about twenty degrees or more than about sixty degrees.

2. The dental implant system of claim 1, wherein, the abutment comprises an implant coupling portion, the implant coupling portion comprising an abutment surface adapted to mate with the inner implant surface.

3. The dental implant system of claim 2, wherein, the abutment surface and the inner implant surface comprise about the same length.

4. The dental implant system of claim 2 wherein, the abutment surface comprises a second angle relative to a vertical plane, the second angle comprising about the same size as the first angle.

5. The dental implant system of claim 2 wherein,
the abutment surface does not contact an entirety of the inner implant surface; and
one or more open spaces are created at least one of between and near the abutment surface and inner implant surface.

6. The dental implant system of claim 6 wherein,
the dental implant system is adapted for placement within soft tissue and bone; and
the soft tissue grows in the one or more open spaces.

7. The dental implant system of claim 6 wherein, soft tissue is manually placed in the one or more open spaces.

8. A dental implant comprising,
a first section adapted to couple to soft tissue; and
a second section adapted to couple to bone; wherein
the first section is adapted to create a biologic width in the soft tissue, the biologic width:
comprising a horizontal distance and a vertical distance, and
being adapted to minimize bone loss.

9. The dental implant of claim 8 wherein, the horizontal distance and the vertical distance comprise a distance from about 2.5 mm to about 3.5 mm.

10. The dental implant of claim 8, wherein,
the dental implant comprises a general cylindrical shape;
the first section:
is adapted to couple to the soft tissue through a first coupling mechanism, and
comprises:
a proximal end,
a distal end,
a centerline, and
an outer surface; and
the second section is adapted to couple to the bone through a second coupling mechanism; and further comprising,
a bore extending at least partially through the first section and the second section, wherein the bore:
is adapted to receive a dental abutment, and
comprises an inclined surface extending from near the outer surface at the proximal end of the dental implant towards the centerline near the distal end.

11. The dental implant of claim 10 wherein, a portion of the dental abutment is adapted to contact the inclined surface.

12. The dental implant of claim 11 further comprising one or more spaces between the abutment and the implant; and wherein, the soft tissue is adapted to grow in the one or more spaces.

13. The dental implant of claim 12, wherein at least one of the horizontal distance and the vertical distance is less than 2.5 mm and the other of the horizontal distance and the vertical distance is greater than 3.5 mm.

14. A method of installing a dental implant comprising,
coupling the dental implant to soft tissue and bone;
coupling a dental abutment to the dental implant;
creating one or more spaces between the dental abutment and the dental implant; and
facilitating growth of the soft tissue in the one or more spaces.

15. The method of claim 14 wherein, the soft tissue comprises a gum, the gum having a gum line.

16. The method of claim 14 further comprising, establishing a biologic width in the gum proximal at least one of the dental implant and dental abutment after creating one or more spaces between the dental abutment and the dental implant.

17. The method of claim 16 wherein,
the biologic width comprises a horizontal distance and a vertical distance; and
at least one of the horizontal distance and the vertical distance is changed upon growth of the soft tissue in the one or more spaces.

18. The method of claim 14 wherein, coupling a dental abutment to the dental implant comprises placing the dental abutment against an inclined surface of the dental implant.

19. The method of claim 18, wherein, placing the dental abutment against an inclined surface of the dental implant comprises placing a dental abutment inclined surface against the inclined surface of the dental implant.

20. The method of claim 19 wherein, the dental abutment inclined surface comprises a diameter different than a diameter of the inclined surface of the dental implant.
